(19) United States
(12) Patent Application Publication
(10) Pub. No.: US 2010/0116065 A1
(43) Pub. Date: May 13, 2010

(54) FLOWMETER

(75) Inventors: Uwe MECKE, Northeim (DE); Uwe Pohl, Uslar (DE); Hans-Werner Schwiderski, Norten-Hardenberg (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/617,360

(22) Filed: Nov. 12, 2009

(30) Foreign Application Priority Data
Nov. 12, 2008 (DE) 10 2008 056 871.6

(51) Int. Cl. G01F 1/32; G01F 1/56; G01F 1/58; G01F 1/84

(52) U.S. Cl. 73/861.11; 73/861.08; 73/861.22; 73/861.354

(57) ABSTRACT

A flowmeter is provided to have a measuring tube, in or on which a measuring system is arranged. The flowmeter includes pinch seal sleeves which are arranged at both ends of the measuring tube for connecting the measuring tube to a process pipeline. According to an exemplary configuration, the pinch seal sleeves and/or the inner surfaces of the pinch seal sleeves are composed of an electrically insulating material and/or coated with an electrically insulating material. To make the device lighter in enable fast installation, the measuring tube can be made flangeless.

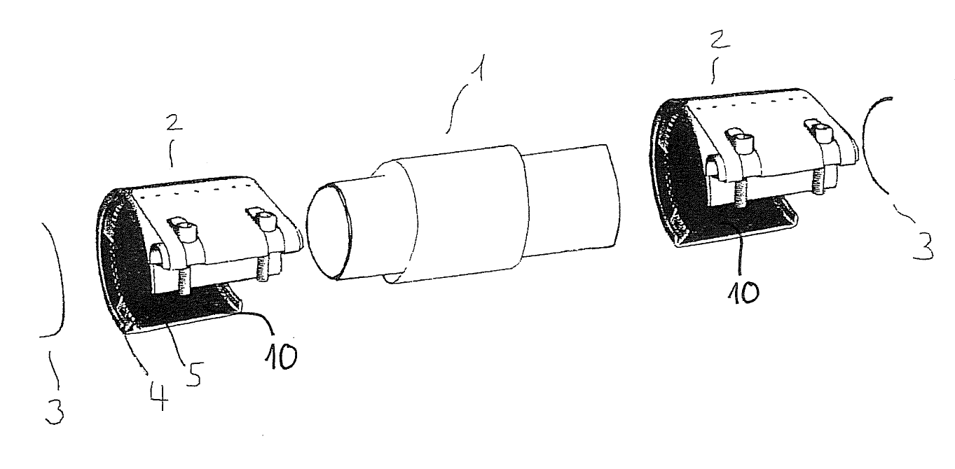

### RELATED APPLICATIONS

This application claims priority under 35 U.S.C. §119 to German Patent Application No. 10 2008 056 871.6 filed in Germany on Nov. 12, 2008, the entire content of which is hereby incorporated by reference in its entirety.

### FIELD

The present disclosure relates to a flowmeter having a measuring tube, in or on which a measuring system is arranged.

### BACKGROUND INFORMATION

The prior art discloses flowmeters which are based on a wide variety of measuring effects and in which a measuring tube is provided. A measuring system is arranged in or on the measuring tube. The measuring tube is inserted, as intended, into a line through which the measurement medium to be measured flows. These are generally tubes or pipelines in waterworks or production plants.

Flange connections are provided for installation of the flowmeter with its measuring tube in the line system. Therefore, flowmeters of a known design are provided with flanges at both ends of the measuring tube.

A disadvantage of this arrangement is that the flanges account for a large part of the costs involved in producing the meter, due to the flanges constituting a major proportion of the weight, and a large amount of space is required during installation.

### SUMMARY

An exemplary embodiment provides a flowmeter which comprises a flangeless measuring tube, in or on which a measuring system is arranged. The exemplary flowmeter also comprises pinch seal sleeves which are arranged at both ends of the measuring tube and are configured to connect the measuring tube to a process pipeline. At least one of the pinch seal sleeves and inner surfaces of the pinch seal sleeves are at least one of composed of an electrically insulating material and coated with an electrically insulating material.

### BRIEF DESCRIPTION OF THE DRAWINGS

Additional refinements, advantages and features of the present disclosure are described in more detail below with reference to exemplary embodiments illustrated in the drawing, in which:

The FIGURE shows an exemplary flowmeter having a measuring tube 1, in which two pinch seal sleeves 2 are fitted to the ends of the measuring tube 1 of the flowmeter and are then clamped to the ends of the measuring tube 1 and the ends of the pipeline 3.

### DETAILED DESCRIPTION

Exemplary embodiments of the present disclosure provide a flowmeter to the effect that the disadvantages described above are avoided.

According to an exemplary embodiment of the present disclosure, the pinch seal sleeves 2 themselves or at least the inner surfaces of the pinch sleeves 2 are composed of an electrically insulating material or are coated with an electrically insulating material. This allows an electrically insulated connection between the measuring tube 1 and the process line 3.

An exemplary embodiment provides that the coating of the inner surfaces of the pinch seal connection or the pinch seal connection itself is composed of electrically insulating plastic.

A functional double effect, namely a good sealing effect in addition to the consequent insulation, is achieved irrespective of whether a measuring tube made of plastic or a measuring tube made of metal is used. The good sealing effect is achieved both if a plastic surface is pressed onto a plastic surface and if a plastic surface is pressed onto a metal surface.

The feature of electrical insulation means that no interference signals occur and the signal generation power can also be minimized.

Another exemplary embodiment provides that the measuring tube 1 of the flowmeter is extremely short such that the dimension ratio V of the installation length to the diameter is less than or equal to 1.3. This feature is possible due to a flangeless design in this exemplary embodiment.

Another exemplary embodiment provides that the pinch seal sleeves 2 are preassembled at both ends of the measuring tube 1.

Another exemplary embodiment provides that the measuring tube 1 is a plastic tube.

Alternatively, however, the measuring tube 1 may be a metal tube, according to an exemplary embodiment.

In both alternatives, the plastic surface of the pinch seal connector 2, which surface is at least in the form of an inner coating, results in considerably better sealing. That is to say, the sealing effect of plastic on plastic is just as good as plastic on metal.

In this case, an exemplary embodiment provides that the measuring tube 1 is connected to the pipeline 3 by means of pinch seal sleeves 2 provided at both ends. In this alternative, it is likewise possible to dispense with flanges on the pipeline 3 at the customer end because the two ends of the pipeline 3 can be respectively inserted into the pinch seal sleeves 2 for the purpose of connecting the flowmeter.

In this case, according to an exemplary embodiment, the pinch seal sleeves 2 may also have already been integrally formed at the ends of the measuring tube 1.

Another exemplary embodiment provides that the two ends of the measuring tube 1 end bluntly and are welded, at the customer end, to the two pipeline ends of that line in which the flow rate is intended to be determined.

Heavy flanges are no longer required on the meter and at the pipeline ends according to the above-described exemplary embodiments, and assembly is greatly improved in terms of ease and assembly time. In terms of their leaktightness, the pinch seal sleeves 2 have the same reliability as flange connections.

According to an exemplary embodiment of the present disclosure, the flowmeter is an inductive flowmeter (IDM). In this widespread design of a highly precise flowmeter, particularly good use can be made of this type of connection to the pipeline.

However, this can also be used for other flowmeters such as capacitive flowmeters, vortex flowmeters and Coriolis flowmeters, for example.

In the exemplary embodiment illustrated in the drawing, two so-called pinch seal sleeves 2 are fitted to the ends of the measuring tube 1 of a flowmeter and are then clamped to the ends of the measuring tube 1 and the ends of the pipeline 3.

In this case, the measuring tube 1 may either be only flangeless and connected to the pipeline at both ends by means of a so-called pinch seal sleeve, or else the respective pinch seal sleeve 2 has respectively already been arranged at both ends of the measuring tube 1. The conduit pipe can then be pushed onto the still unclamped open end and thereafter clamped to the process line 3.

The pinch seal sleeves 2 illustrated in the FIGURE are used when the ends of the measuring tube end bluntly, according to at least one exemplary embodiment.

According to the illustrated exemplary embodiment, the inside 10 of the pinch seal sleeve 2 is provided with an electrically insulating layer, such as a plastic layer, for example. In addition to a good sealing effect, the plastic layer has an electrically insulating effect when combined with a metal tube. Depending on the type of flowmeter, such as magnetic-inductive or capacitive, for example, a considerable metrological effect is also provided with respect to signal optimization and reduction in the amount of excitation energy used for the magnetic system and/or the electrodes.

Collars 4 which are folded inward at both ends and grip the ends of the pipeline 3 in a force-fitting manner during clamping are included in such a pinch seal sleeve. A sealing lip 5 or annular sealing lip arranged behind the collars 4 can then produce a correspondingly leaktight connection.

According to an alternative configuration, the pinch seal sleeves 3 may have already been integrally formed at the measuring tube 1 ends.

This novel connection of flowmeters may be applied to all common types of flowmeters.

The inventive refinement of the electrically insulating inner coating or else the refinement of the entire pinch seal sleeve made of plastic is effective in each of these possible configurations.

The flangeless design in this exemplary embodiment also means that the dimension ratio V of the installation length to the diameter is less than or equal to 1.3, or such a ratio can be achieved.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A flowmeter comprising:
a flangeless measuring tube, in or on which a measuring system is arranged; and
pinch seal sleeves which are arranged at both ends of the measuring tube and are configured to connect the measuring tube to a process pipeline,
wherein at least one of the pinch seal sleeves and inner surfaces of the pinch seal sleeves are at least one of composed of an electrically insulating material and coated with an electrically insulating material.

2. The flowmeter as claimed in claim 1, wherein the coating of the inner surfaces of the pinch seal forming the connection with the measuring tube is composed of electrically insulating plastic.

3. The flowmeter as claimed in claim 1, wherein the measuring tube of the flowmeter is short such that the dimension ratio V of the installation length to the diameter of the measuring tube is less than or equal to 1.3.

4. The flowmeter as claimed in claim 1, wherein the pinch seal sleeves are preassembled at both ends of the measuring tube.

5. The flowmeter as claimed in claim 2, wherein the measuring tube is a plastic tube.

6. The flowmeter as claimed in claim 2, wherein the measuring tube is a metal tube.

7. The flowmeter as claimed in claim 1, wherein the flowmeter is an inductive flowmeter IDM.

8. The flowmeter as claimed in claim 1, wherein the flowmeter is a capacitive flowmeter.

9. The flowmeter as claimed in claim 1, wherein the flowmeter is a vortex flowmeter.

10. The flowmeter as claimed in claim 1, wherein the flowmeter is a Coriolis flowmeter.

11. The flowmeter as claimed in claim 1, wherein the pinch seal connection is composed of an electrically insulating plastic.

12. The flowmeter as claimed in claim 11, wherein the measuring tube is a plastic tube.

13. The flowmeter as claimed in claim 11, wherein the measuring tube is a metal tube.

14. The flowmeter as claimed in claim 3, wherein the measuring tube is a plastic tube.

15. The flowmeter as claimed in claim 3, wherein the measuring tube is a metal tube.
